(19) United States
(12) Patent Application Publication
(10) Pub. No.: US 2003/0014193 A1
(43) Pub. Date: Jan. 16, 2003

(54) Analysis of catalysed reactions by calorimentry

(76) Inventor: David Keith Ramsden, West Yorkshire (GB)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/182,692

(22) PCT Filed: Jan. 23, 2001
(86) PCT No.: PCT/EP01/00700

(30) Foreign Application Priority Data
Feb. 4, 2000 (GB) 0002464.6

(51) Int. Cl. G06F 19/00

(52) U.S. Cl. 702/23

(57) ABSTRACT

A method for monitoring catalysed reactions comprising measuring the change of temperature with time of a sample of the reaction mixture during at least part of the reaction when the heat lost or gained by the sample is less than the heat production or heat reduction respectively of the reaction and using said measurement to determine the concentration of one of the reactants.

This invention relates to the control of catalysed reactions by calorimetry and more particularly the control of biocatalysed reactions.

In catalysed reactions it is important to be able to monitor the activity of the catalyst and the extent to which the reaction has proceeded. This is particularly so with biocatalysis of the kind described in PCT publication WO 97/21827 in which acrylonitrile is converted to ammonium acrylate using nitrilase enzyme, the nitrilase enzyme being described in PCT publication WO 97/21805. That biocatalyst is deactivated by acrylonitrile at relatively low concentrations for example >500 mM. In order to deal with that the bioreactor is run in fed batch mode so that the acrylonitrile concentration can be kept at a low level. In the fed batch type of reaction the acrylonitrile is fed into the bioreactor at a predetermined rate calculated to be below the capacity of the catalyst to convert the acrylonitrile.

As the reaction proceeds the concentration of ammonium acrylate rises and this causes some deactivation of the catalyst. If the feed of acrylonitrile continues at the same predetermined rate the amount of acrylonitrile will eventually exceed the capacity of the catalyst to convert it. This leads to yet further deactivation of the catalyst so that the problem gets progressively worse. As a result the catalyst can be destroyed and the reaction is halted prematurely. The failure of the reaction cannot be predicted and is generally only noticed after it is too late to make any adjustment to the acrylonitrile feed to keep the reaction going.

It is thus necessary to know what the acrylonitrile concentration is during the course of the conversion so that the acrylonitrile feed to the bioreactor can be adjusted between upper and lower limits (the lower limit not necessarily being zero) in order to keep the reaction going. As an alternative or additionally measurement of the activity of the biocatalyst can be used to control the reaction conditions.

What is required therefore is the ability to measure the concentration and rate of conversion of low concentrations of acrylonitrile in the presence of high concentrations, for example 25 to 50% w/w, of ammonium acrylate. And for the control of the production of a commodity chemical the measurement method should desirably be cheap, simple, fast and fairly sensitive, for example±20 ppm substrate concentration.

Various methods have been suggested but none of them meet the above criteria. Thus in a spectrophotometric method the free cell catalyst causes interference; in a chromatographic method, for example HPLC, low acrylonitrile concentrations are obscured in the presence of high ammonium acrylate concentrations and in addition catalyst would have to be removed or the catalyst quenched in order to stop the reaction immediately, for example by filtration. A head-space gas-liquid chromatography system for measurement of volatile acrylonitrile needs to be equilibriated for each sample and this causes a delay. Methods based on conductivity measurements to obtain the concentration of acrylonitrile are insensitive. Mass balance derivation of the acrylonitrile concentration from the mass of added acrylonitrile with an on line conductimetric determination of the ammonium acrylate product concentration is not suitable due to the non-linear, often hyperbolic relationship between the fluid conductance and the ammonium acrylate concentration above an ammonium acrylate concentration of 10% w/w. At high ammonium acrylate concentrations the conductance reduces with an increase in product concentration.

GB1217325 discusses a method of measuring the rate of reaction in a reaction mixture by isolating a sample of the mixture and recording its change of temperature with time, under adiabatic conditions. However no method of measuring the reactant concentration is provided.

The present invention has been made with these problems in mind.

According to the invention there is provided a method for the monitoring of catalysed reactions comprising measuring the change of temperature with time of a sample of the reaction mixture isolated from reactant feed during at least part of the reaction when the heat lost or gained by the sample is less than the heat production or heat reduction respectively of the reaction and using said measurement to calculate the concentration in the reaction mixture of at least one of the reactants. It is preferred that the reaction in the sample should be a zero order reaction and proceed as far as possible under adiabatic conditions by reducing the heat transfer between the reactant and the surroundings to zero or close to zero. For an enzyme a zero order reaction is often where the substrate concentration is in excess of Km. However whilst constant adiabatic conditions throughout the sample may be difficult to achieve they can be achieved for the 2 to 5 minutes required to measure the rate of reaction by maintaining stagnant liquid conditions around the site of temperature measurement. The initial part of the temperature/time curve will have a slope approaching that of adiabatic conditions and this can be used to provide information about the activity of the catalyst. Generally for measurement of the reaction rate the duration of the initial part of the time/temperature curve which is under adiabatic conditions should not be less than about 1 minute, usually not less than 2.5 minutes, a preferred duration being about 4.0 minutes. If the time taken for one reactant to be exhausted is also measured, then the concentration of that reactant may also be determined.

It is also useful to ensure that the temperature change in the sample is not so great that it causes the reaction to accelerate and cause error in the measurement of the reaction rate. The temperature change is ideally not more than 5° Celcius, preferably the temperature change is not more than 2° Celcius.

An important feature of the invention is that the total temperature rise (or fall) does not need to be known. In particular, the activity of the catalyst can be calculated from the slope of the initial part of the time/temperature profile and the concentration of reactant determined from the activity of the catalyst and the duration of the temperature rise (or fall).

In a preferred embodiment of the invention the sample of the reaction mixture from a reactor is held in an insulated vessel. The reaction is allowed to progress and the temperature rise or fall is measured, for example with a temperature probe, whereby the time/temperature curve is established. Preferably samples are successively taken from the reactor so that the progress of the reaction in the reactor is regularly monitored and adjustments can be made to the conditions in the reactor as appropriate. A convenient arrangement for taking samples from the reactor comprises a vessel, preferably insulated, through which fluid from the reactor is circulated. At intervals the circulation is stopped so that a fixed quantity of reaction mixture, i.e. the sample, is held in the vessel and the temperature measurements made. Although this in-line type of sampling is convenient it is not essential. It is quite possible to take samples by simply removing a part of the reaction mixture from the reactor and placing the sample in an insulated vessel whereupon the temperature profile of the reaction in the sample can be determined. If desired the insulated vessel could be preheated to the temperature of the sample so as to reduce heat loss when the sample is introduced into the insulated vessel.

A specific embodiment of the invention will now be described by way of example with reference to the accompanying drawings in which:

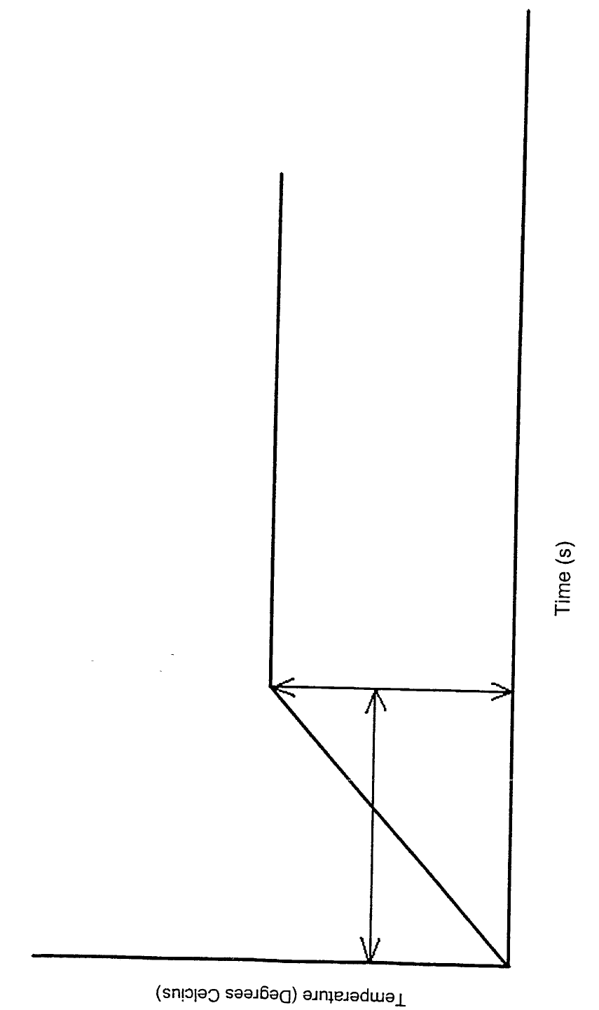

FIG. 1 is a temperature/time curve of a zero order reaction under adiabatic conditions where a reactant is exhausted in time t_{D};

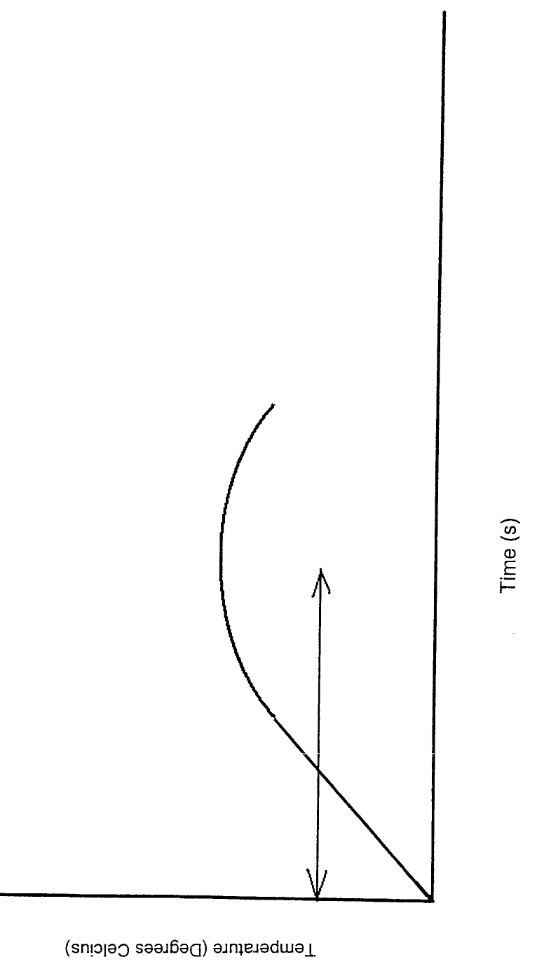

FIG. 2 is a temperature/time curve of a reaction where conditions are initially adiabatic and then heat loss is small and where the reactant is exhausted in time t_{D};

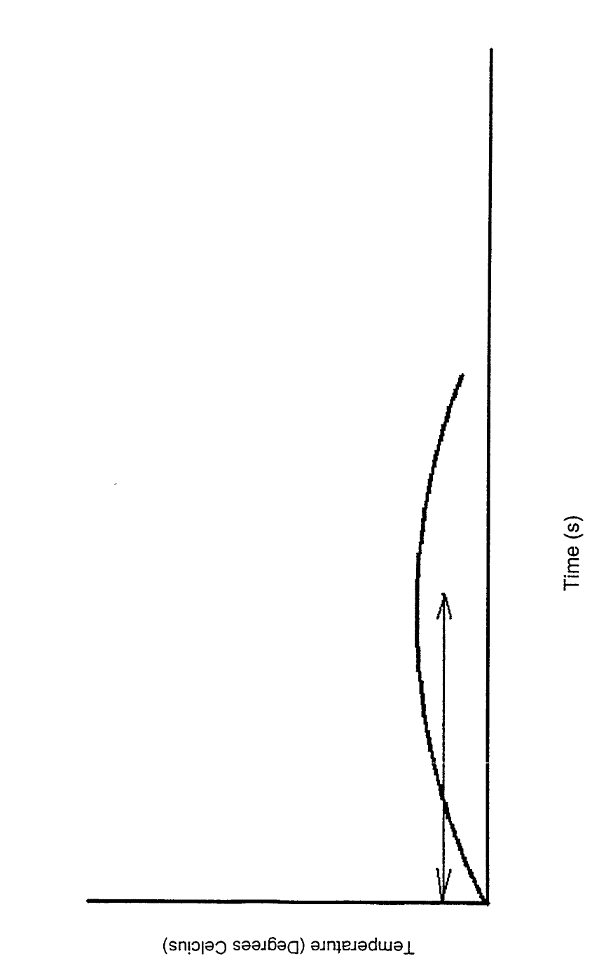

FIG. 3 is a temperature/ time curve of a reaction where the conditions are non-adiabatic;

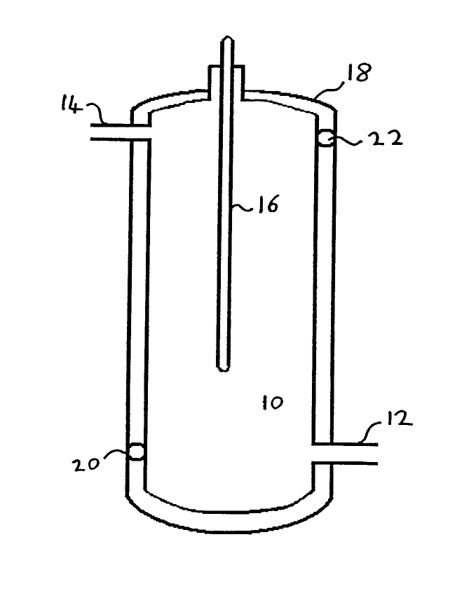

FIG. 4 is a vertical cross section through one form of calorimeter detector that can be used to carry out the invention;

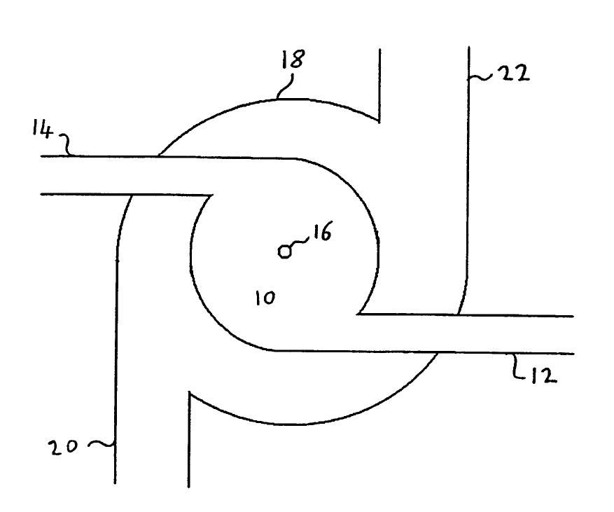

FIG. 5 is a transverse section through the calorimeter of FIG. 4;

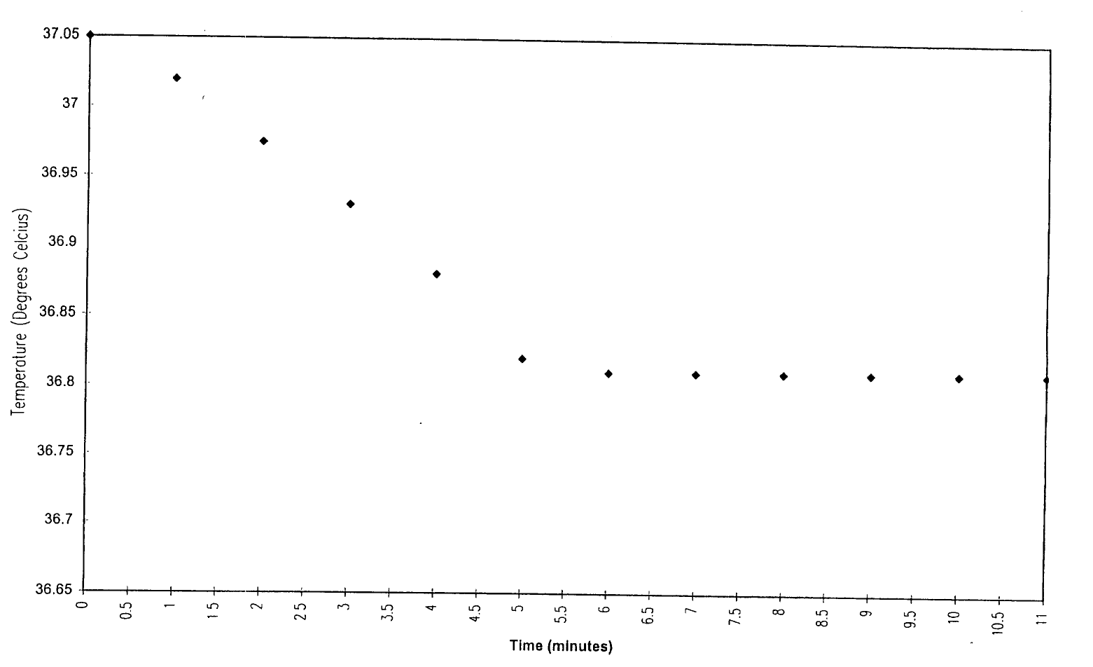

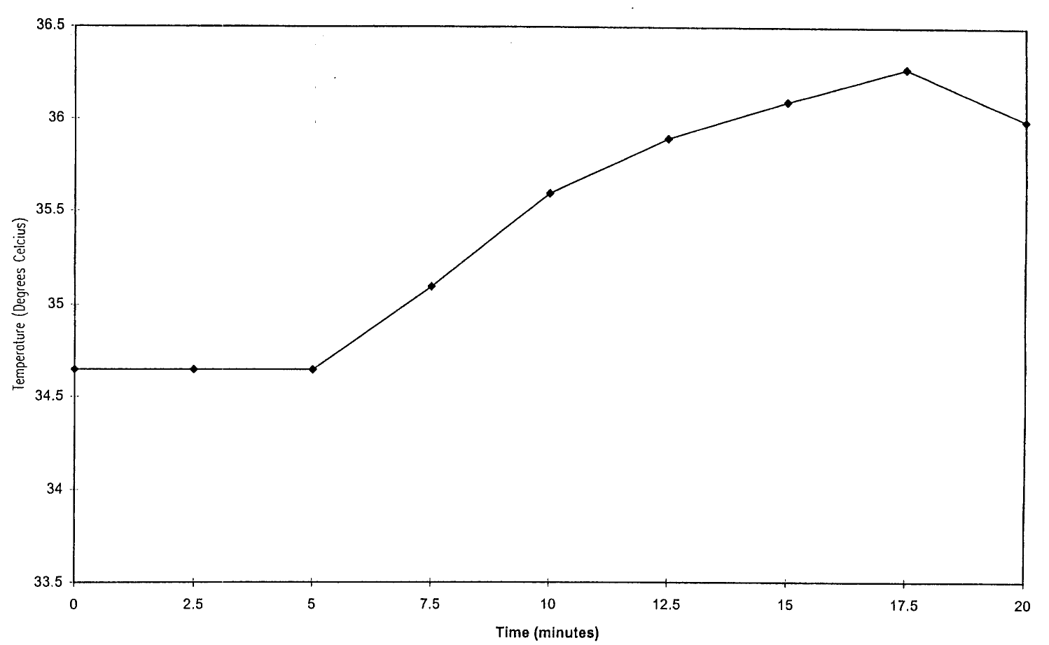

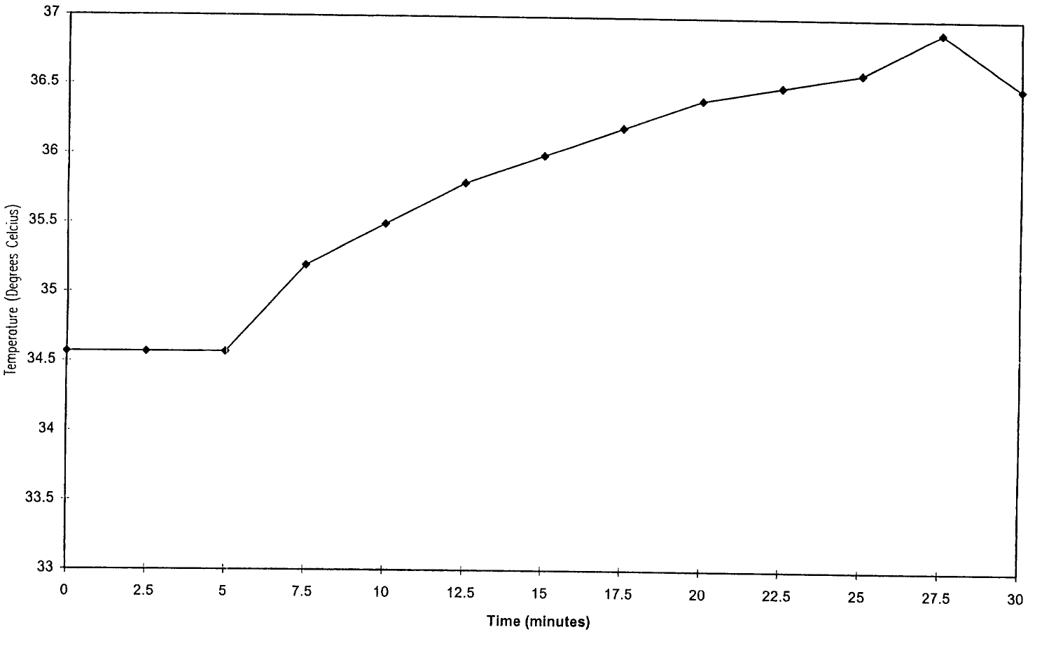

FIGS. 6 to 9 are temperature/time profiles obtained when carrying out the invention, FIGS. 8 and 9 showing a linear temperature rise with time after the adiabatic period, due to a constant rate of heat loss;

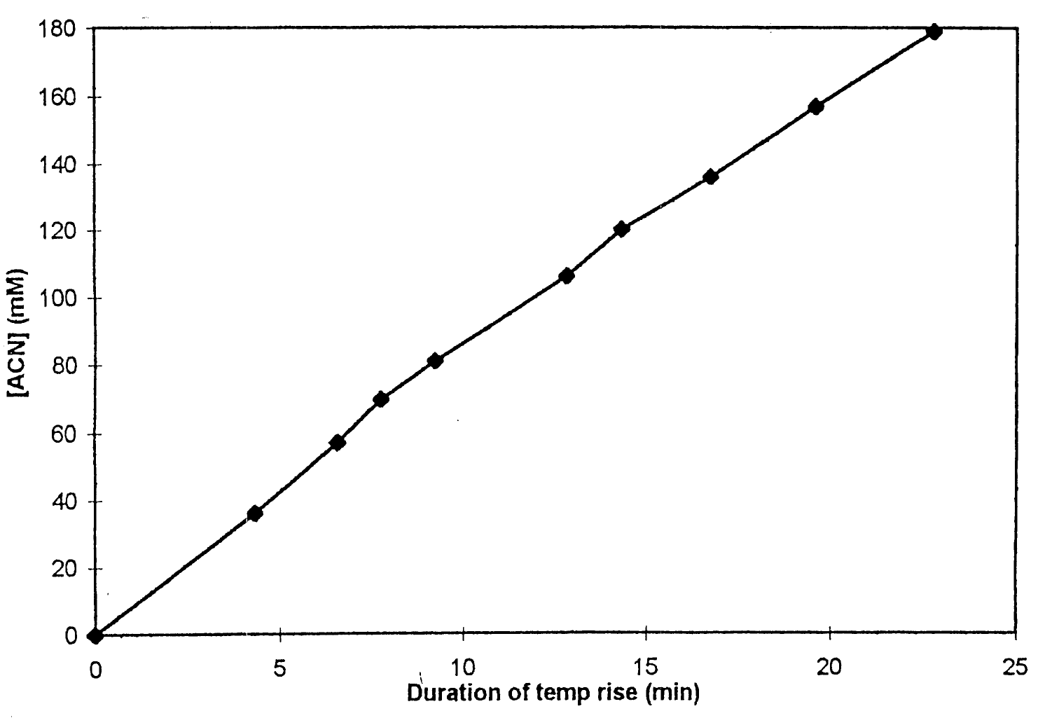

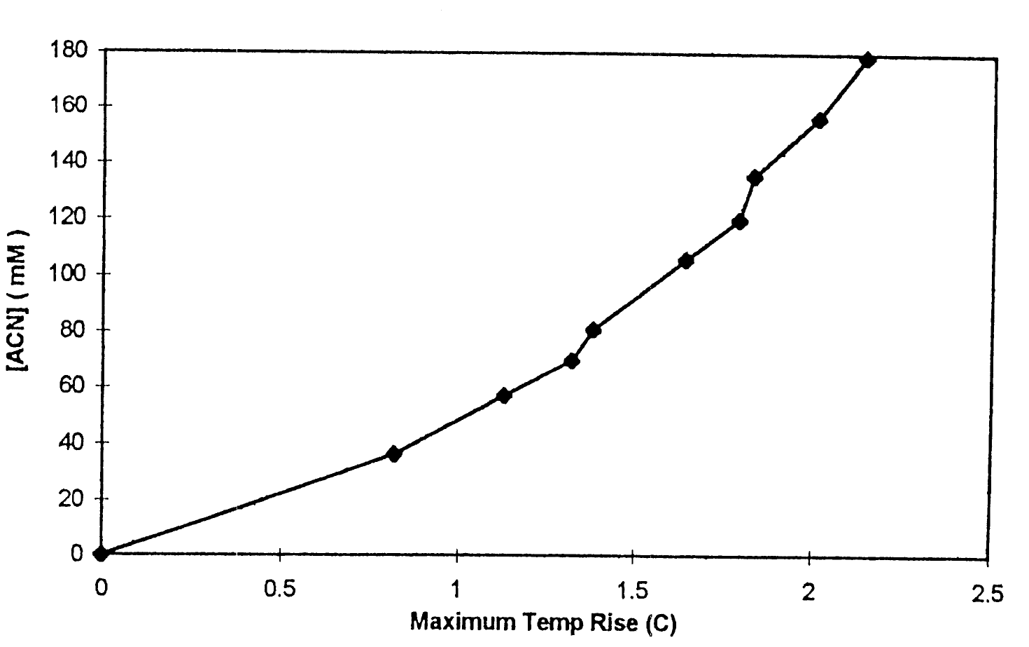

FIGS. 10 and 11 are curves showing the relationship between acrylonitrile concentration on the one hand and the duration of temperature rise and observed maximum temperature rise on the other hand;

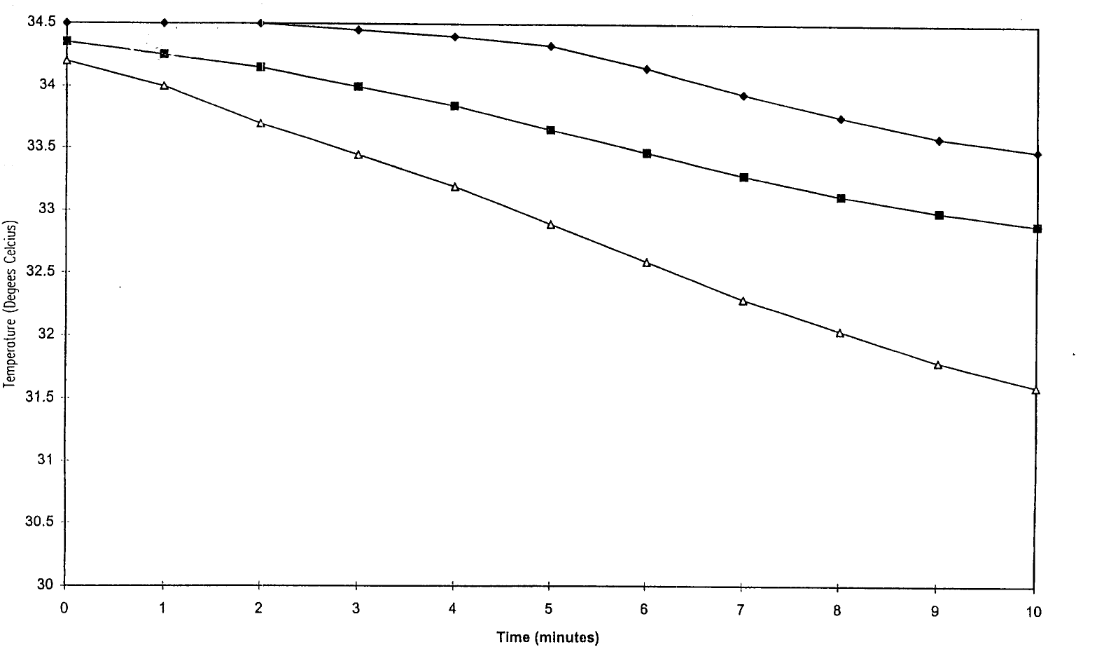

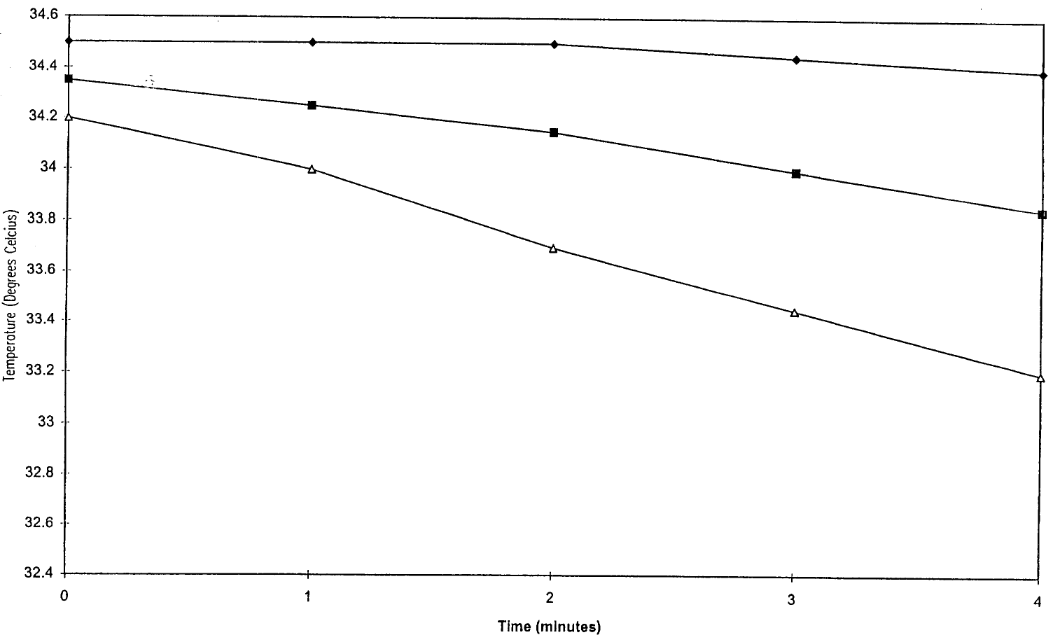

FIGS. 12 and 13 show cooling curves obtained with three different kinds of calorimeter and shows that the calorimeter favorably influences the adiabatic period and subsequent rate of cooling, each calorimeter shows an initial adiabatic region followed by a period of constant rate heat loss, the curve represented by diamonds is obtained from a calorimeter in which both inner and outer vessels contain reaction fluid, the curve represented by squares is obtained with the inner vessel containing reaction fluid and the outer vessel open to atmosphere and containing air, the curve represented by triangles is obtained from a simple container having no outer vessel; and

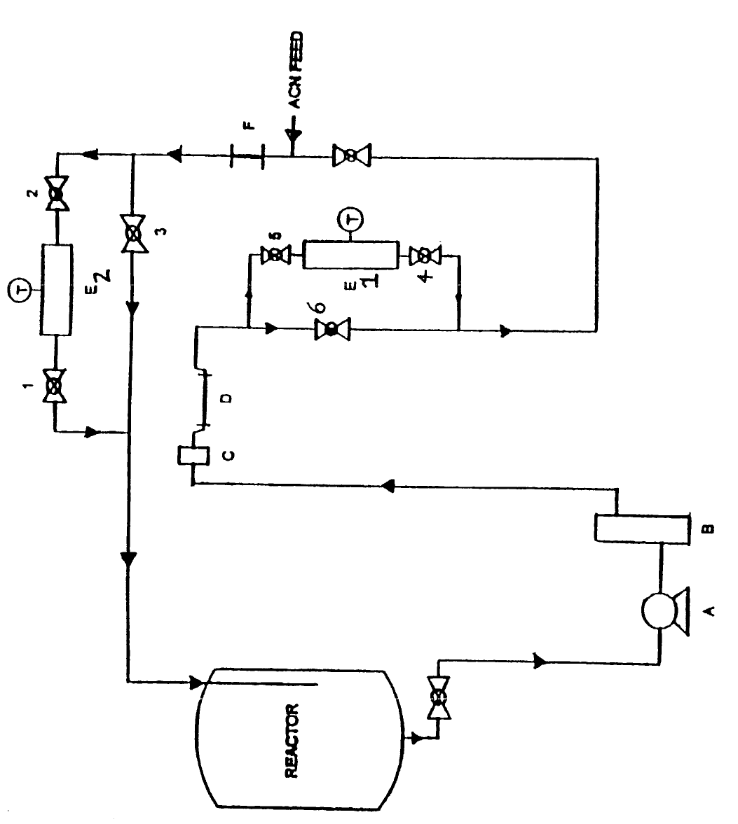

FIG. 14 is a system for carrying out the invention employing two calorimeters wherein:

A represents a recirculation pump, type PU 1304

B represents a heat exchanger, type HE 1311

C represents a neotecha inline sampler

D represents a conductivity sensor

E represents a calorimetric analyser

F represents an inline mixer of 100 mm length

T represents a temperature sensor;

In the specific description of the invention reference is made to the bioconversion of acrylonitrile to ammonium acrylate using nitrilase enzyme as biocatalyst. Alternatively the invention may be used in a process of producing acrylamide from acrylonitrile. It is to be understood however that the invention is not limited to use with that reaction only.

A sample from a reactor for the above bioconversion is placed in a calorimeter and the temperature measured. Since the bioconversion of acrylonitrile to ammonium acrylate is exothermic and zero order, such as with the nitrilase as described in PCT publication WO 97/21827, the temperature will rise at a constant rate until substantially all the acrylonitrile has been converted. The ideal circumstances are shown in FIG. 1 where heat loss from the calorimeter is zero and the reaction proceeds under adiabatic conditions, t_{D}= duration of temperature rise and ΔT = Maximum temperature rise. From FIG. 1 the following calculations can be made:

| | | |
|---|---|---|
| Activity of the biocatalyst (A) | = k1 * slope | (1) |
| Concentration of acrylonitrile | = A * t_{D} | (2) |
| Concentration of acrylonitrile | = k2 * ΔT | (3) |

k1 and k2 are constants which can be found by calibration or derived from relationships between the constants and the heat of reaction and heat capacity of the reaction mixture.

Thus from the slope and value of k1, the activity A of the biocatalyst can be obtained and using the catalyst activity and the duration of the temperature rise the concentration of acrylonitrile can be determined. The third equation above shows that the concentration of acrylonitrile can also be found from the maximum temperature rise but as already indicated that is not the preferred way of obtaining the acrylonitrile concentration. It is also expected that the activity of the catalyst allows the substrate conversion rate to be predicted. In this way an algorithm can be written which predicts an ideal substrate feed rate to maintain a set substrate concentration and which lends itself to computerised control of the process.

As already explained, it is often not feasible nor is it necessary to reduce the heat loss from the calorimeter to zero for the duration of the reaction. All that is necessary is that the rate of heat loss should be well below the rate of heat generation, preferably it is zero for an initial period. This is shown in FIG. 2. There is a gradual fall off in the slope but the initial part of the curve is substantially the same as the adiabatic curve of FIG. 1. As shown in FIG. 3 the temperature loss is greater and the conditions are non-adiabatic for example in an agitated reaction mixture. What is required is that there is sufficient duration of the initial part of the curve which is under adiabatic conditions to establish the slope, the activity of the catalyst being calculated using equations1 rewritten as:

Activity of biocatalyst =k1 * Initial slope

It will be noted that under conditions where the rate of heat loss is well below the rate of heat generated the duration of the temperature rise is unaffected by the heat loss and therefore the concentration of acrylonitrile can still be calculated using equation 2. Where there is heat loss the maximum temperature rise is less than in the adiabatic reaction and the relationship of maximum temperature rise with the concentration of acrylonitrile becomes complex. Equation 3 therefore only holds under adiabatic conditions.

In an alternative form of the invention the contents of the reactor are circulated through a loop configuration. This may be a simple conduit through which the reaction mixture is passed and then returned to the reactor. In this form of the invention the fresh substrate feed is introduced into the loop configuration before entering the reactor, whereby the substrate is mixed with the circulating reaction mixture in the loop configuration before being passed into the reactor vessel.

FIG. 14 shows such apparatus wherein the loop configuration contains a calorimeter before the substrate feed point and a calorimeter placed after the substrate feed point, wherein bypass tubes connect the loop immediately before and after the calorimeters. The bypass tubes allow the contents of the reactor to flow around the loop when the reaction mixture is isolated within a calorimeter.

The change of temperature of an isolated portion of the reaction mixture is measured with time in each calorimeter placed in the loop configuration before the introduction of substrate and after the introduction of substrate in order to determine the temperature change of the reaction medium.

This loop configuration may comprise more than one calorimeter placed before and/or after the substrate feed point, as the use of multiple calorimetric detectors can provide an almost continuous reading of the acrylonitrile concentration.

Preferably the change of temperature with time measurements are substantially immediately prior to the substrate feed point and substantially immediately after the substrate feed point.

A preferred method of taking the measurements in the loop configuration is by aid of one calorimeter positioned in the loop configuration prior to the substrate feed point and one calorimeter positioned in the loop configuration after the substrate feed point, as shown in FIG. 14.

According to a further aspect of the invention the concentration of at least one of the reactants in a reaction is determined by taking a sample of the reaction mixture and subjecting the sample of reaction mixture to a catalysed reaction and in which the heat lost or gained by the sample is less than the heat production or heat reduction respectively of the reaction and using said measurement to calculate the concentration in the reaction mixture of at least one of the reactants. In a preferred form of this aspect of the invention the sample of reaction mixture is subjected to a different reaction. This alternative form of the invention may be of value when the catalysed reaction of the sample is more endothermic or more exothermic than the main reaction. Thus the rate of heat generation or heat reduction would be greater than in the main reaction but the measured concentration of reactant(s) would still be that of the main reaction.

This aspect of the invention may be of particular value for reactions which are not substantially exothermic or substantially endothermic, provided that the reactant(s) for which the concentration(s) are to be determined can be subjected to an exothermic or endothermic catalysed reaction in the sample. This aspect of the invention may be of value in the production of acrylamide from acrylonitrile, wherein a sample of the reactor contents could be combined with a suspension of nitrilase cells which convert the acrylonitrile to ammonium acrylate. This may be of value in any process for the production of acrylamide from acrylonitrile, for instance employing a Raney copper catalyst or a biocatalyst. The bio-conversion of acrylonitrile to ammonium acrylate is more exothermic than the bio-conversion of acrylonitrile to acrylamide. Thus the concentration of the acrylonitrile in the reactor may be determined more accurately by converting the acrylonitrile in the sample to acrylate rather than simulating the conversion to acrylamide.

Thus in this aspect of the invention there is provided a method for the monitoring of reactions comprising measuring the change of temperature with time of a sample of the reaction mixture isolated from reactor during at least part of the reaction when the heat lost or gained by the sample is less than the heat production or heat reduction respectively of a catalysed reaction of the sample and using said measurement to calculate the concentration in the reaction mixture of at least one of the reactants.

A further aspect of the invention provides a method for the monitoring of fermentations which produce enzymic catalysts comprising measuring the change of temperature with time of a sample of the fermentation mixture isolated from the fermentation vessel when the heat lost or gained by the sample is less than the heat production or heat reduction respectively of the fermentation and using said measurement to calculate the activity of the catalyst produced by the fermentation.

This may be done in a number of ways. One method includes the use of two calorimeters (of the type described previously), one which contains a fermentation mixture and another which contains an identical fermentation mixture and substrate.

For example, the preferred fermentation mixture may produce acrylonitrile hydrolase, thus the substrate would be acetonitrile. Measuring the difference in the rate of the heat rise between the two calorimeters provides data from which the activity of the enzymic catalyst (or concentration of substrate) may be calculated, in a similar way as described previously.

This differential rate of temperature increase must be used as a fermentation reaction differs from a bioconversion in that the fermentation consists of many biological reactions which affect the temperature of the fermentation mixture. So the control calorimeter is needed to take into account the temperature difference due to the fermentation.

Alternatively, two calorimeters may be used in which either substrate or enzyme is added to one of the calorimeters to measure the activity of the catalyst present in the fermentation mixture or to measure the substrate concentration in the fermentation mixture.

Alternatively, a single calorimeter may be used which may be of the type described previously, and contains the fermentation mixture and substrate. A sample may be taken from the mixture and filtered to remove any cellular material from the fermentation prior to transfer to the calorimeter, and the enzyme is then added to the sample so that the rate of temperature increase may be measured, from which the concentration of substrate may be calculated, in a similar way as described previously.

It is preferred that the reaction in the sample should be a zero order reaction and proceed as far as possible under adiabatic conditions by reducing the heat transfer between the reaction and the surroundings to zero or close to zero. For an enzyme a zero order reaction is often where the substrate concentration is in excess of Km of the enzyme under the, operating conditions. However whilst constant adiabatic conditions throughout the sample may be difficult to achieve they can be achieved for the 2 to 5 minutes required to measure the rate of reaction by maintaining stagnant liquid conditions around the site of temperature measurement. The initial part of the temperature/time curve will have a slope approaching that of adiabatic conditions and this can be used to provide information about the activity of the catalyst. Generally for measurement of the reaction rate the duration of the initial part of the time/temperature curve which is under adiabatic conditions should not be less than about 1 minute, usually not less than 2.5 minutes, a preferred duration being about 4.0 minutes. If the time taken for one reactant to be exhausted is also measured, then the concentration of that reactant may also be determined.

It is also useful to ensure that the temperature change in the sample is not so great that it causes the reaction to accelerate and cause error in the measurement of the reaction rate. The temperature change is ideally not more than 5° Celcius, preferably the temperature change is not more than 2° Celcius.

An important feature of the invention is that the total temperature rise (or fall) does not need to be known. In particular, the activity of the catalyst can be calculated from the slope of the initial part of the time/temperature profile and the concentration of reactant determined from the activity of the catalyst and the duration of the temperature rise (or fall).

In a preferred embodiment of the invention the sample of the reaction mixture from a reactor is held in an insulated vessel. The reaction is allowed to progress and the temperature rise or fall is measured, for example with a temperature probe, whereby the time/temperature curve is established. Preferably samples are successively taken from the reactor so that the progress of the reaction in the reactor is regularly monitored and adjustments can be made to the conditions in the reactor as appropriate. A convenient arrangement for taking samples from the reactor comprises a vessel, preferably insulated, through which fluid from the reactor is circulated. At intervals the circulation is stopped so that a fixed quantity of reaction mixture, i.e. the sample, is held in the vessel and the temperature measurements made. Although this in-line type of sampling is convenient it is not essential. It is quite possible to take samples by simply removing a part of the reaction mixture from the reactor and placing the sample in an insulated vessel whereupon the temperature profile of the reaction in the sample can be determined. If desired the insulated vessel could be preheated to the temperature of the sample so as to reduce heat loss when the sample is introduced into the insulated vessel.

In an alternative form of the invention the contents of the reactor are circulated through a loop configuration. This may be a simple conduit through which the reaction mixture is passed and then returned to the reactor. In this form of the invention the fresh substrate feed is introduced into the loop configuration before entering the reactor, whereby the substrate is mixed with the circulating reaction mixture in the loop configuration before being passed into the reactor vessel.

The change of temperature of an isolated portion of the reaction mixture is measured with time in each calorimeter placed in the loop configuration before the introduction of substrate and after the introduction of substrate in order to determine the temperature change of the reaction medium.

This loop configuration may comprise more than one calorimeter placed before and/or after the substrate feed point, as the use of multiple calorimetric detectors can provide an almost continuous reading of the acrylonitrile concentration.

Preferably the change of temperature with time measurements are substantially immediately prior to the substrate feed point and substantially immediately after the substrate feed point.

A preferred method of taking the measurements in the loop configuration is by aid of one calorimeter positioned in the loop configuration prior to the substrate feed point and one calorimeter positioned in the loop configuration after the substrate feed point, as shown in FIG. 14.

According to a further aspect of the invention the concentration of at least one of the reactants in a reaction is determined by taking a sample of the reaction mixture and subjecting the sample of reaction mixture to a catalysed reaction and in which the heat lost or gained by the sample is less than the heat production or heat reduction respectively of the reaction and using said measurement to calculate the concentration in the reaction mixture of at least one of the reactants. In a preferred form of this aspect of the invention the sample of reaction mixture is subjected to a different reaction. This alternative form of the invention may be of value when the catalysed reaction of the sample is more endothermic or more exothermic than the main reaction. Thus the rate of heat generation or heat reduction would be greater than in the main reaction but the measured concentration of reactant(s) would still be that of the main reaction.

This aspect of the invention may be of particular value for reactions which are not substantially exothermic or substantially endothermic, provided that the reactant(s) for which the concentration(s) are to be determined can be subjected to an exothermic or endothermic catalysed reaction in the sample. This aspect of the invention may be of value in the production of acrylamide from acrylonitrile, wherein a sample of the reactor contents could be combined with a suspension of nitrilase cells which convert the acrylonitrile to ammonium acrylate. This may be of value in any process for the production of acrylamide from acrylonitrile, for instance employing a Raney copper catalyst or a biocatalyst. The bio-conversion of acrylonitrile to ammonium acrylate is more exothermic than the bio-conversion of acrylonitrile to acrylamide. Thus the concentration of the acrylonitrile in the reactor may be determined more accurately by converting the acrylonitrile in the sample to acrylate rather than simulating the conversion to acrylamide.

Thus in this aspect of the invention there is provided a method for the monitoring of reactions comprising measuring the change of temperature with time of a sample of the reaction mixture isolated from reactor during at least part of the reaction when the heat lost or gained by the sample is less than the heat production or heat reduction respectively of a catalysed reaction of the sample and using said measurement to calculate the concentration ion the reaction mixture of at least one of the reactants.

The following Examples further illustrate the invention:

### EXAMPLE 1.

A calorimeter of the concentric type as shown in FIGS. 4 and 5 was used. The calorimeter comprises an inner vessel 10 of circular cross section having an inlet 12 and an outlet 14 connected to a bioreactor (not shown). A temperature probe 16 extends into the vessel 10. An outer vessel 18 concentrically surrounds the inner vessel 10 and is provided with an inlet 20 and outlet 22 for the admission of fluid at substantially the same temperature as reaction mixture in the inner vessel thereby reducing heat loss from the inner vessel. The distance (or amount of insulation) between the source or sources of cooling and the place of temperature measurement can be varied depending on the length of time under adiabatic conditions required. Preferably the fluid in the outer vessel is the same as the reaction mixture in the inner vessel held under the same stagnant conditions as the reaction mixture in the inner vessel so that its heat rise due to the reaction is substantially the same as that within the inner vessel thus helping to maintain adiabatic conditions As can be seen in FIG. 5 the inlets and outlets to both vessels are arranged tangentially so as to ensure good mixing of the fluid in the vessels.

The bioreactor to which the calorimeter was connected was charged with water and biocatalyst. Acrylonitrile was pumped into the bioreactor at a rate slightly in excess of the bioconversion rate of the biocatalyst so that the concentration of acrylonitrile slowly increased in the bioreactor. Reaction mixture from the bioreactor was continually pumped through the calorimeter and back to the bioreactor. As a result, while reaction mixture was being circulated through the calorimeter, the temperature in the calorimeter was constant relative to the temperature in the bioreactor. At selected intervals the pump circulating reaction mixture between the bioreactor and calorimeter was turned off and a temperature/time profile of the conditions in the calorimeter obtained by measurements taken from several minutes, for instance approximately 5 minutes before the circulation to the calorimeter was stopped until the temperature in the calorimeter began to fall. From these profiles the slope of the temperature/time curve, the duration of temperature rise and the maximum temperature rise were determined. At the same time as the circulation to the calorimeter was stopped a sample of reaction mixture was taken and immediately filtered to remove the biocatalyst for determination of the acrylonitrile concentration.

Reference is now made to FIGS. 6 to 9 which show the profiles obtained. The profile of FIG. 6 shows the conditions in the calorimeter before the feed of acrylonitrile to the bioreactor was started. The temperature in the calorimeter fell during the period of five minutes before circulation of reaction mixture to the calorimeter was discontinued. Thereafter the temperature remained constant for about a further five minutes. This is the adiabatic period. After that the temperature fell due to heat loss to the surroundings.

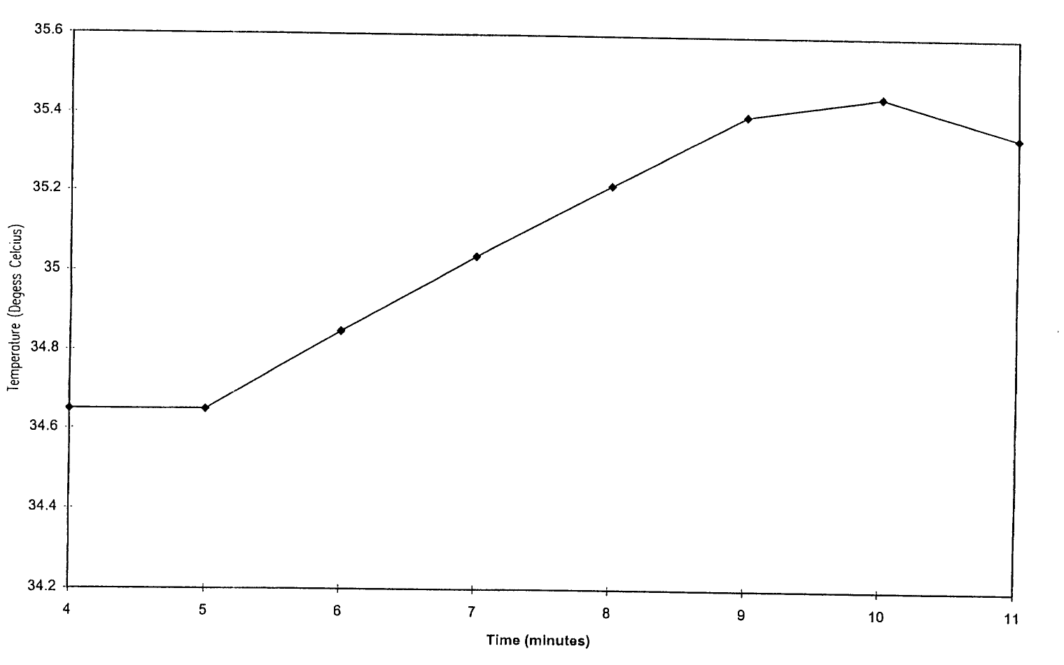

The profile in FIG. 7 was obtained when the acrylonitrile concentration had reached 36 mM. As can be seen, after five minutes, when the circulation was stopped, the temperature rises linearly with time within the adiabatic period of about five minutes. From the slope of the linear rise in the temperature and from the duration of the temperature rise, in this case 4.32 minutes, the activity of the catalyst and the concentration of acrylonitrile can be obtained. At the end of the linear rise in temperature the curve starts to fall indicating that the reaction in the calorimeter has come to an end.

The temperature/time profile shown in FIG. 8 is taken after a period of time when the concentration of acrylonitrile in the bioreactor had built up to about 100 mM. The duration of the temperature rise is now 12.82 minutes But only the initial linear part, that is within the first five minutes of the temperature/time curve corresponding to the adiabatic region, is used for the determination of the slope for the purpose of calculating the activity of the biocatalyst. After about the first five minutes of the temperature rise the curve becomes flatter and then falls abruptly at the end of the reaction.

The profile shown in FIG. 9 was obtained when the concentration of acrylonitrile in the bioreactor had reached 180 mM. As before the profile is linear over the adiabatic region and from this part of the temperature/time curve the slope enables the activity of the biocatalyst to be determined. After the linear region the curve becomes flatter due to heat losses from the calorimeter, which are almost constant, and thereafter falls.

### EXAMPLE 2

The equipment and procedure was the same as in Example 1 except that circulation between the bioreactor and calorimeter was stopped every half hour for a temperature/time profile to be obtained and at the same time a sample was removed from the bioreactor for determining the concentration of acrylonitrile. The acrylonitrile concentration plot against the duration of temperature rise is shown in FIG. 10 and reveals a proportionality between these two values However as can be seen in FIG. 11 no such proportionality exists between values of the acrylonitrile concentration and the maximum temperature rises obtained from successive samples.

It will be appreciated that the invention provides not only a means for monitoring the progress of a biocatalysed reaction but also enables the reaction to be controlled using the information obtained from the method of the invention. Thus the variation of acrylonitrile concentration with time as obtained by the invention can be used to adjust the acrylonitrile feed in order to maintain the concentration at the desired level. In addition the values of the activity of the catalyst can be used to adjust the amount of catalyst in the bioreactor so that if desired a constant level of activity can be maintained.

The fall in concentration of acrylonitrile in the calorimeter corresponds with the fall in concentration of acrylonitrile in the bioreactor. A simple control procedure is to discontinue the feed of acrylonitrile to the reactor at a predetermined delay time into each sampling period until the temperature in the calorimeter starts to fall. At that point the acrylonitrile feed to the bioreactor is re-started. This procedure prevents the concentration of acrylonitrile in the bioreactor falling to zero. The length of the delay time determines the concentration of acrylonitrile in the reactor when the feed is restarted.

Referring now to FIGS. 12 and 13 cooling curves are shown for different types of calorimeter. The curve represented by diamonds is obtained from a calorimeter as described above with reference to FIGS. 4 and 5 when both inner and outer vessels contain reaction fluid. The curve represented by squares is obtained with the inner vessel containing reaction fluid and the outer vessel open to atmosphere and containing air. The curve represented by triangles was obtained from a simple container having no outer vessel. As can be seen the best results are obtained from the concentric design of FIGS. 4 and 5 with reaction fluid in the outer vessel.

In applying the invention to a reactor for example for the conversion of acrylonitrile to ammonium acrylate using nitrilase enzyme a system as illustrated in FIG. 14 can be used. In this system first calorimeter 30 is positioned to receive reaction mixture from the reactor 32 via recycle line 34. This calorimeter is used to determine the acrylonitrile concentration in the reactor and can be used to determine the activity of the catalyst provided that there is sufficient acrylonitrile in the reactor to provide a heat rise slope, preferably greater than 1 minute, in the calorimetric detector. Since it is possible that there may be no acrylonitrile present in the reaction mixture received by the first calorimeter 30 a second calorimeter 36 is positioned between the acrylonitrile feed 38 into the recycle line 34 and the reactor 32 in order to measure the zero order reaction rate with an assured minimum level of acrylonitrile.

The invention is not limited to the above described embodiments and many modifications and variations can be made. For example there are other ways to carry out the calorimetric detection. Thus a sampler can simply be dipped into the contents of the reactor. In another embodiment the feed to the reactor can be discontinued and any agitation of the reaction mixture in the reactor switched off whereafter the heat rise of the entire stagnant contents of the reactor is measured.

The use of multiple calorimetric detectors operated, sequentially can provide a near to real time continuous reading of the acrylonitrile concentration. Yet another method comprises mixing the biocatalyst into a flow of reactants and then holding the mixture under stagnant conditions while measuring the heat rise.

1. A method for monitoring a catalysed reaction comprising measuring the change of temperature with time of a sample of the reaction mixture during at least part of the reaction when the heat lost or gained by the sample is less than the heat production or heat reduction respectively of the reaction and using said measurement to determine the concentration of one of the reactants.

2. A method as claimed in claim 1, wherein the reaction in the sample proceeds at least in part under adiabatic or substantially adiabatic conditions.

3. A method as claimed in claim 1 or claim 2, wherein the reaction in the sample proceeds under adiabatic or substantially adiabatic conditions for not less than 1 minute, preferably not less than 2.5 minutes.

4. A method as claimed in any preceding claim, wherein the heat gain or loss by the sample is reduced substantially to zero during said at least a part of the reaction.

5. A method as claimed in any preceding claim, wherein the reaction is exothermic.

6. A method as claimed in any preceding claim, wherein during said at least part of the reaction the sample is held in an insulated vessel.

7. A method as claimed in any preceding claim, wherein samples are successively taken from a reactor.

8. A method as claimed in claim 7 wherein reaction mixture is circulated between the reactor and a sampling vessel and at intervals the circulation is discontinued so as to leave a sample of reaction mixture in the sampling vessel upon which said measurements are made.

9. A method as claimed in claim 7 or 8 as appendent to claim 6, wherein the vessel for the sample is heated to the temperature of the reaction mixture.

10. A method as claimed in any preceding claim, wherein the change of temperature with time of the sample is measured with a temperature probe.

11. A method as claimed in any preceding claim, wherein the measurements obtained from the sample are used to control the reaction.

12. A method as claimed in claim 11, wherein the reaction is controlled by adjusting the concentration of one of the reactants in the reaction mixture.

13. A method as claimed in claim 11 or claim 12 wherein the reaction is controlled by adjusting the content of catalyst in the reaction mixture.

14. A method as claimed in any of claims 11 to 13, wherein the reaction is controlled by discontinuing the feed of one of the reactants to the reaction mixture while the sample is being measured.

15. A method as claimed in any preceding claim, wherein the reaction is bio-catalysed.

16. A method as claimed in any preceding claim, wherein the catalyst is an enzyme selected from nitrilase and nitrile hydratase.

17. A method as claimed in any preceding claim, wherein the reaction is the conversion of acrylonitrile to ammonium acrylate catalysed by nitrilase enzyme.

18. A method as claimed in any preceding claim, wherein the reaction is catalysed by an enzyme and the concentration of substrate is in excess of the Km value that the enzyme has for the substrate.

19. A method as claimed in any preceding claim, wherein the reaction follows zero order kinetics until substantially complete.

20. A method as claimed in any preceding claim wherein the contents of the reactor are circulated through a loop configuration and the substrate feed is introduced into loop configuration before entering the reactor and wherein the change of temperature with time of isolated portions of the reaction mixture are measured before the introduction of substrate and after the introduction of substrate in order to determine the temperature change of the reaction medium.

21. A method according to claim 20 wherein the change of temperature with time measurements in the loop configuration are made by the aid of one or more calorimeters positioned in the loop configuration prior to the substrate feed point, one or more calorimeters positioned in the loop configuration after the substrate feed point and a means of allowing the contents of the reactor to flow around the loop when the reaction mixture is isolated within a calorimeter.

22. A method for monitoring a reaction comprising measuring the change of temperature with time of a sample of the reaction mixture during at least part of the reaction when the heat lost or gained by the sample is less than the heat production or heat reduction respectively of a catalysed reaction in the sample, measuring the time taken for one reactant to be exhausted and using said measurements to calculate the concentration in the reaction mixture of at least one of the reactants.

23. A method according to claim 22 in which the catalysed reaction in the sample is more exothermic or more endothermic than the reaction.

24. A method according to claim 22 or claim 23 in which the reaction is the conversion of acrylonitrile into acrylamide.

25. A method according to any one of claims 22 to 24 in which the catalysed reaction in the sample is the conversion of acrylonitrile to ammonium acrylate, employing nitrilase.

26. A method according to any one of claims 22 to 24 incorporating any of the features of claims 1 to 21.

27. A method for monitoring a fermentation which produces enzymic catalysts comprising measuring the change of temperature with time of a sample of the fermentation mixture isolated from the fermentation vessel when the heat lost or gained by the sample is less than the heat production or heat reduction respectively of the fermentation and using said measurement to determine the activity of the catalyst produced by the fermentation.

28. A method as claimed in claim 27, wherein the fermentation in the sample proceeds at least in part under adiabatic or substantially adiabatic conditions.

29. A method as claimed in claim 27 or claim 28, wherein the fermentation in the sample proceeds under adiabatic or substantially adiabatic conditions for not less than 1 minute, preferably not less than 2.5 minutes.

30. A method as claimed in any preceding claim, wherein the heat gain or loss by the sample is reduced substantially to zero during said at least a part of the fermentation.

31. A method as claimed in any preceding claim, wherein the fermentation is exothermic.

32. A method as claimed in any preceding claim, wherein during said at least part of the fermentation the sample is held in an insulated vessel.

33. A method as claimed in any preceding claim, wherein samples are successively taken from a reactor.

34. A method as claimed in claim 33 wherein the fermentation mixture is circulated between the reactor and a sampling vessel and at intervals the circulation is discontinued so as to leave a sample of fermentation mixture in the sampling vessel upon which said measurements are made.

35. A method as claimed in claim 33 or 34 as appendent to claim 32, wherein the vessel for the sample is heated to the temperature of the fermentation mixture.

36. A method as claimed in any of claims 27 to 35, wherein the change of temperature with time of the sample is measured with a temperature probe.
